(19) United States
(12) Patent Application Publication
(10) Pub. No.: US 2004/0160129 A1
(43) Pub. Date: Aug. 19, 2004

(54) Apparatus and method for automatically locking and unlocking power flow to an electrical cord using a timer

(76) Inventor: Peter Steinar Dahlberg, Salt Lake City, UT (US)

Correspondence Address: PETER S. DAHLBERG, 8364 S. AUSTRIAN WAY, SALT LAKE CITY, UT, 84121, US

(21) Appl. No.: 10/356,811

(22) Filed: Feb. 3, 2003

(51) Int. Cl. H02B 1/24

(52) U.S. Cl. 307/116

(57) ABSTRACT

This disclosure describes an electrical power cord, which, by using a programmable on/off power timer, will enable or disable power from flowing through said power cord. It also describes a method for locking and unlocking a plug to and from the female receptacle of said power cord. The purpose of such a power cord is to control the time of use of any electrical device that may be plugged in to said power cord, by programming a programmable on/off power timer to allow a flow of current to that device at desired periods during a week and by locking the plug of said device to the female receptacle of said power cord. The programmable on/off power timer is locked within the same enclosure as the said plug. When the appropriate key is used, the timer can be accessed for programming, or the plug may be removed.

### STATEMENT REGARDING FEDERAL SPONSORED RESEARCH AND DEVELOPMENT

This invention is not the result of any federally sponsored research or development funding.

### BACKGROUND OF THE INVENTION

Many parents are concerned about the their children spending too much time in front of the television, or watching shows that the parents would rather they not watch. Parents are also concerned about the amount of time their children spend playing electronic games. Parents may not wish to allow children access to a personal computer and/or the Internet when the parent is not present to supervise. And generally, the interest in controlling and restricting access to any device powered by electricity may involve issues of security, propriety and control.

While various means exist to control access to televisions (e.g., V-Chip), computers (e.g., various types of security programs) and other devices, these are all generally of a “high-technology” nature, and understanding or controlling these devices is often beyond abilities of many people. Further, these means are often specific to the particular device, and do not provide a simple, low-cost, easy-to-use solution for universally controlling and restricting access to any and all devices powered by electricity in a fully generic manner. Simple power locking devices are available but require a person to be present to lock and unlock a power supply with a key. A device that automatically locks and unlocks power flow using a timer allows a parent to control the particular time and amount of time children may access electrical devices when the parent is not present.

### SUMMARY OF THE INVENTION

The invention disclosed herein is an Apparatus and Method for Automatically Locking and Unlocking Power Flow to an Electrical Cord Using a Timer. The Apparatus used to achieve this combines in a novel manner, two devices long known in the electrical and mechanical arts: a simple programmable on or off power timer, and physical “locking and unlocking” devices, respectively.

The invention is really quite simple, and is embodied in a simple electrical device, which can be in the form of an “extension cord” type device. This device, on one end, contains a standard “male” plug that plugs directly into a standard power outlet. On the other end, it contains a standard “female” socket, into which the “male” plug providing power to any electrical apparatus (e.g., television, computer) can be plugged in order to receive power. However, this device is further provided with a programmable on or off power timer mechanism that either disables or enables the flow of power through the device, depending upon the program of the programmable timer. A person may program the timer to allow power to electrical devices for specific time periods and not allow power to electrical devices during other times.

Of course, without more, it would still be possible for someone to circumvent this Apparatus and Method for Locking and Unlocking Power Flow to an Electrical Cord, by simply unplugging the subject electrical device from this “extension/adapter” apparatus, and replugging it directly into the standard power outlet. Alternately, someone could modify the program of the programmable timer. Thus, it is further necessary to establish some means (a “programmable on or off power timer/plug envelope”) by which the programmable on or off power timer and male plug providing power to the electrical apparatus can be locked and secured to the female socket of this apparatus, such that these two cannot be separated by someone other than the person who holds the key to lock or release said “envelope.”

In summary, this invention therefore combines in a novel manner, a simple programmable on or off power timer, with simple a mechanical locking device. It further provides a secure programmable on or off power timer/plug envelop that could readily be devised by someone of ordinary skill in the mechanical arts, without undue experimentation, in many different embodiments. As a whole, this invention provides a useful, novel and nonobvious Apparatus and Method for Automatically Locking and Unlocking Power Flow to an Electrical Cord Using a Timer.

### BRIEF DESCRIPTION OF THE DRAWING

FIG. 1 depicts the key elements of the invention, embodied in an extension cord apparatus with a “lock” and “key” set, controlling the securing/releasing of the programmable on or off power timer/plug envelope.

### DETAILED DESCRIPTION OF THE PREFERRED EMBODIMENT OF THE INVENTION

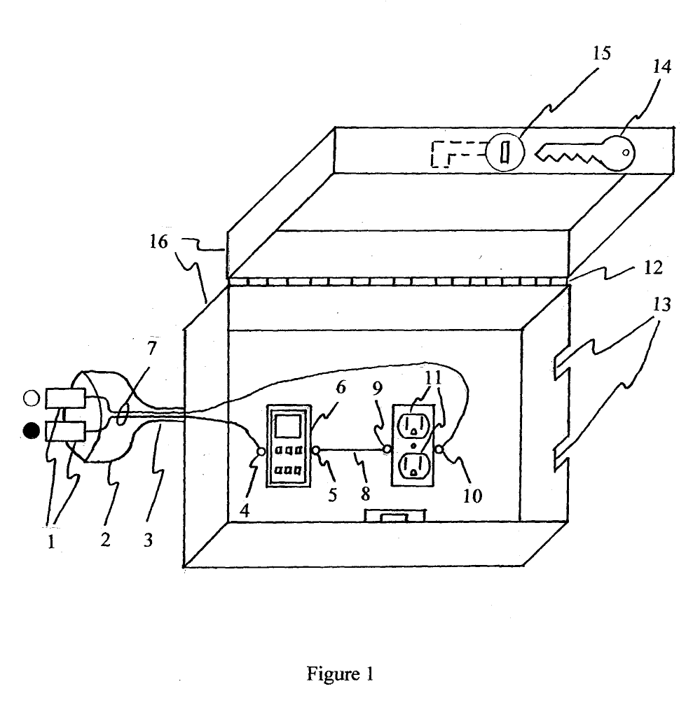

FIG. 1 depicts the key elements of the invention, embodied in an extension cord apparatus with a “lock” and “key” set, controlling the securing/releasing of the programmable on or off power timer /plug envelope.

A standard male plug 2 is depicted comprising a pair of standard electrical prongs 1, wherein the darkened adjacent circle depicts a “hot” node (often associated with a “black” wire) and the undarkened adjacent circle depicts a “cold” node (often associated with a “white” wire). For safety purposes, a standard ground prong and associated wiring can readily be introduced as well, though this is not strictly necessary for this invention and is not depicted here.

A power cord 3 houses a pair of electrical wires 7 making an electrical connection at one end to the prongs 1, and at the other end, to automatic timer input node 4 and female receptical node 10. The automatic timer input node 4 is “hot”, and the female plug input node 10 is “cold”.

A programmable timer 6 will allow power to flow from node 4 to node 5 during time periods when the timer has been programmed for power on. During time periods when the timer has been programmed for power off, power will be disabled from flowing from node 4 to node 5. When the programmable timer is on the, the node 5 becomes “hot.” When the programmable timer is off, the node 5 becomes “cold.”

There are numerous types of programmable timers that are readily available that all will achieve the same result of switching power on and off automatically per a program that a person can modify at will. Some timers combine electronic semiconductor based timers with electromechanical switches other timers are completely mechanical and use pins or tabs inserted on a twenty-four hour wheel that turn power on and off according to the placement of the pin or tab on the wheel. While some timers have advantages over others in many respects, any timer that can be programmed to automatically turn power on and off may be used as programmable timer 6. However, a timer that is equipped with a battery backup that will retain the correct time and the programmed on and off times in the event of a power failure or power interruption is preferred.

Further, a electrical wire 8 making an electrical connection at one end to node 5, and at the other end, to node 9 will facilitate a completed electrical circuit through the female electrical receptacles 11 housed in a standard female electrical socket when the programmable timer is in the on position and a male plug that provides power to any electrical apparatus is inserted into one of the female electrical receptacles 11.

Thus, when the standard male plug 2 is plugged into a standard electrical outlet, and a power cord from any electrical apparatus is plugged into the female receptacle 11, the ability of the electrical apparatus to receive power from the standard electrical outlet is controlled by the programmable timer 6, described thus far.

While the electrical connections described thus far suffice to “lock” and “unlock” the flow of power to an electrical cord plugged in to the female electrical receptacle 11, they do not, by themselves, prevent someone from simply unplugging the electrical cord from the female electrical receptacle 11, and simply replugging the electrical cord directly into the electrical outlet. To prevent this, a locking/unlocking means is required to firmly secure the electrical cord within the programmable on or off power timer/plug envelope, such that the electrical cord male plug cannot be removed from the programmable on or off power timer/plug envelope without the proper key.

The programmable on or off power timer/plug envelope 16 is a box that is made of a durable material such as steel. The lid of the box is hinged on one side using hinge 12. On the opposite side of the lid is a keyed latch 15. The keyed latch 15 is actuated by the key 14 to either open or secure the programmable on or off power timer/plug envelope.

The programmable on or off power timer/plug envelope secures the male plug of an electrical cord using cord openings 13 that are of sufficient dimensions to allow the cord to pass in and out of the programmable on or off power timer/plug envelope but of dimensions too small to allow the male plug to pass through the opening. While it is possible to unplug a power cord from female receptacle 11 by pulling on the power cord external to the programmable on or off power timer/plug envelope, it will not be possible to remove the male plug from the secured programmable on or off power timer/plug envelope and plug it into another female receptacle without damaging the power cord.

Finally, it is emphasized that while this disclosure discusses the locking and unlocking of the programmable on or off power timer/plug envelope and the power flow in terms of a mechanical keyed lock and a programmable on or off power timer, one could design the invention disclosed herein using a variety of mechanical, non-mechanical or semi mechanical “lock and key” technologies that are well known. Further, numerous varieties of power timers that are well known could be used. While this disclosure depicts a two-pronged, ungrounded, 120-volt standard U.S. male plug and female outlets, it is obvious that a ground wire can easily be added, and that this same invention can be implemented in an obvious manner for voltages and plug configurations other than those used in the U.S.

I claim:

1. A secured programmable power flow control apparatus, comprising:
a power conduit;
programmable on or off power timer means therefor for disabling a flow of power through said power conduit by causing a switch of said power conduit to open and thereby interrupt said flow of power through said power conduit when said programmable on or off power timer is programmed to so-disable the power flow, and for re-enabling said flow of power through said power conduit by causing said switch to close and thereby reinitiate said flow of power through said power conduit when said programmable on or off power timer means is programmed to so-re-enable the power flow;
a lockable and unlockable programmable on or off power timer/plug envelope and key means therefor for securing to and thereby preventing the unauthorized programming of said programmable on or off power timer or removal of a plug from said power conduit by locking said programmable on or off power timer/plug envelope into a position enveloping said programmable on or off power timer/plug while said plug is plugged into said power conduit, and for releasing and thereby enabling removal of said plug from said power conduit by using said key means to unlock said programmable on or off power timer/plug envelope and thereby enable programming of said programmable on or off power timer or said plug envelope to be moved out of said position so-enveloping said plug; whereby one is prevented from unlocking said plug lock and thereby removing said plug from said power conduit without access to said key means.

2. The apparatus of claim 1, wherein said power conduit comprises a power cord.

3. A method for automatically locking and unlocking the flow of power through a power conduit from a power source to a plug, comprising the steps of:
automatically disabling said flow of power through said power conduit by causing a switch of said power conduit to open and thereby interrupt said flow of power through said power conduit when the programmable on or off power timer is programmed to so-disable the power flow;
automatically re-enabling said flow of power through said power conduit by causing said switch to close and thereby reinitiate said flow of power through said power conduit when said programmable on or off power timer means is programmed to so re-enable the power flow;
securing to and thereby preventing the removal of said plug from said power conduit by locking a plug envelope into a position enveloping said plug while said plug is plugged into said power conduit; and
securing to and thereby preventing the programming of said programmable on or off power timer by locking a programmable on or off power timer envelope into a position enveloping said programmable on or off power timer while said programmable on or off power timer is connected to control power out of said power conduit; and
releasing and thereby enabling removal of said plug from said power conduit by unlocking said plug envelope and thereby enabling said plug envelope to be moved out of said position so-enveloping said plug, using key means; whereby
one is prevented from reprogramming said programmable on or off power timer and thereby modifying the time periods at which said flow of power through said power conduit may occur without access to said key means; and
one is prevented from unlocking said plug lock and thereby removing said plug from said power conduit without access to said key means.
